(19) United States
(12) Patent Application Publication
(10) Pub. No.: US 2002/0118601 A1
(43) Pub. Date: Aug. 29, 2002

(54) Variable frequency sound generator

(76) Inventor: Melvin A. Freund, Westerville, OH (US)

Correspondence Address: Melvin A. Freund, 785 Collingwood Drive, Westerville, OH, 43081, US

(21) Appl. No.: 10/051,959

(22) Filed: Jan. 15, 2002

Related U.S. Application Data
(60) Provisional application No. 60/263,727, filed on Jan. 25, 2001.

(51) Int. Cl. G10K 9/10; G10K 9/00; G10K 5/00; B06B 3/00; H04B 1/02

(52) U.S. Cl. 367/137; 116/137 R

(57) ABSTRACT

A low frequency sound generator is depicted in FIG. 1, having a resonator tube with an open end and a closed end, with a pulsing mechanism for admitting puffs of compressed gas into the closed end for purposes of producing sound waves out of the open end. The pulsing mechanism resides inside, and is movable along the axis of the resonator tube at the closed end, providing the means of closure for said resonator tube. The axial position of the pulsing mechanism is set through adjusting means, and determines the effective length of the resonator tube, thereby controlling the resonant frequency of the emitted sound.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING

Not Applicable

### BACKGROUND OF THE INVENTION

The invention pertains to a low frequency sound generator capable of producing sound at preferred frequencies by being able to adjust its effective length. It is in particular suited for applications where ash and soot are removed from operating boiler systems by exposing the affected areas with high intensity, low frequency sound.

Low frequency sound has been used for cleaning of ash and soot from fossil fuel boiler heat exchange surfaces and particulate removal systems for over twenty years. In this period the application of these devices has become more scientific and less trial-and-error. Experience and computer generated acoustic analyses have shown that certain sound frequencies are preferable for given boiler systems, each individual system having its own unique frequency response characteristics.

In order to efficiently generate the sound power levels necessary to effect cleaning, it is advantageous to utilize resonating sound generators powered by compressed gas such as that outlined in U.S. Pat. No. 4,517,915. In order to obtain resonance, it is necessary to have a resonator tube or horn body that has the appropriate effective length for generating sound at the desired frequency. The actual resonant frequency will also be affected by the temperature and molecular weight of the gas used for generation of the sound. Compressed air is the usual gas of choice.

Musical wind instruments accomplish this task by having various ports that can be opened or closed along the length of a tube, valves that divert the sound through ancillary tube loops, or slides to produce resonance at various frequencies. The basic premise for this invention is to place the gas pulsing mechanism required for producing the sound inside the closed end of the resonator tube where it can be variably positioned inside of the resonator tube to obtain a desired effective length.

Because low frequencies are used for the cleaning task, the effective lengths of the resonator tubes must of necessity be long. By changing the effective length as described, the outboard dimensions and location of the compressed gas inlet connection can be fixed, simplifying the installation and support structure of the mechanical equipment. The effective length can be changed remotely, allowing ongoing adjustments and automatic operation.

### BRIEF SUMMARY OF THE INVENTION

The objective of this invention is to allow tuning of the output sound frequency of a low frequency sound generator while maintaining the advantages of using a resonator to efficiently produce the sound. A secondary objective is to accomplish this ability without complicating the installation design or process.

In a low frequency sound generator with a resonator tube with a closed end and an open end, and a pulsing mechanism that modulates puffs of compressed gas into the closed end of the tube for the purpose of generating sound out of the open end of the tube, where the pulsing mechanism utilizes feedback to keep the output frequency at the fundamental frequency of the resonator tube or one of its harmonics, the improvement being a pulsing mechanism that is located inside the closed end of the resonator tube or an extension of the resonator tube that also acts as the closure means for the resonator tube in such a fashion as to allow axial adjustment of the location of the pulsing mechanism to change the effective acoustic length of the resonator tube and consequently the frequency of the generated sound.

### BRIEF DESCRIPTION OF THE SEVERAL VIEWS OF THE DRAWING

FIG. 1 shows two sound generators according to the invention, one having the pulser retracted to have a shorter effective length of the resonator tube, and the other having the pulser extended to have a longer effective length. The closed end of the sound generator with pulser is shown in sectional form to allow comparison of position of internal components.

FIG. 2 shows a sectional view of the closed end of the sound generator.

### DETAILED DESCRIPTION OF THE INVENTION

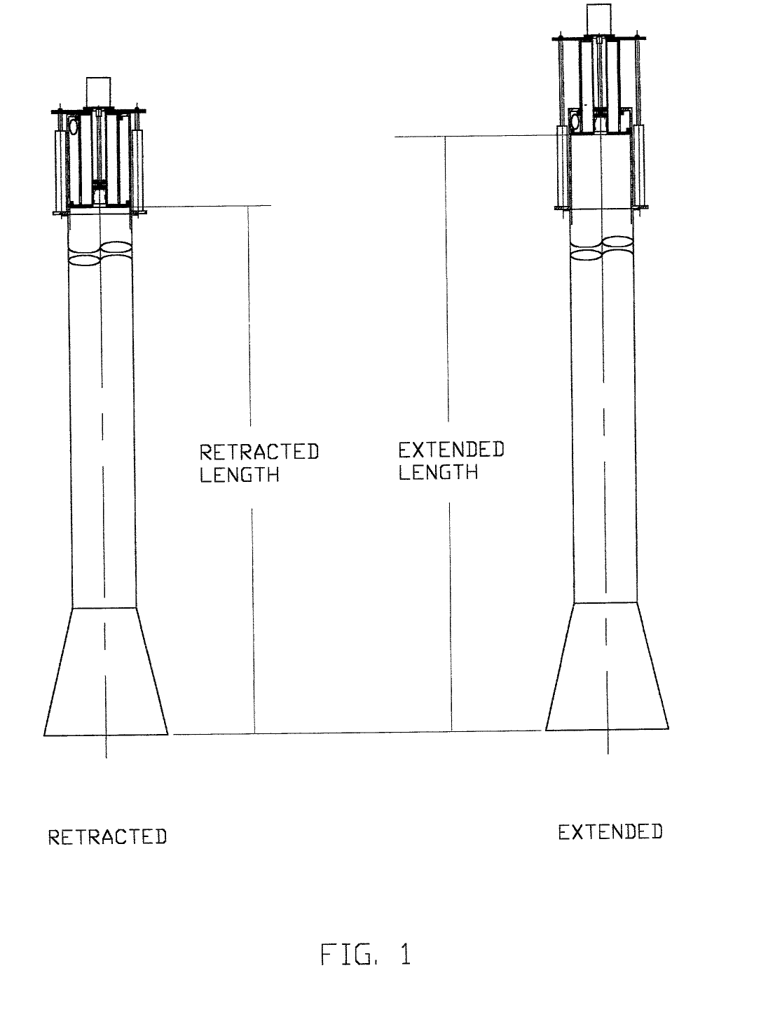

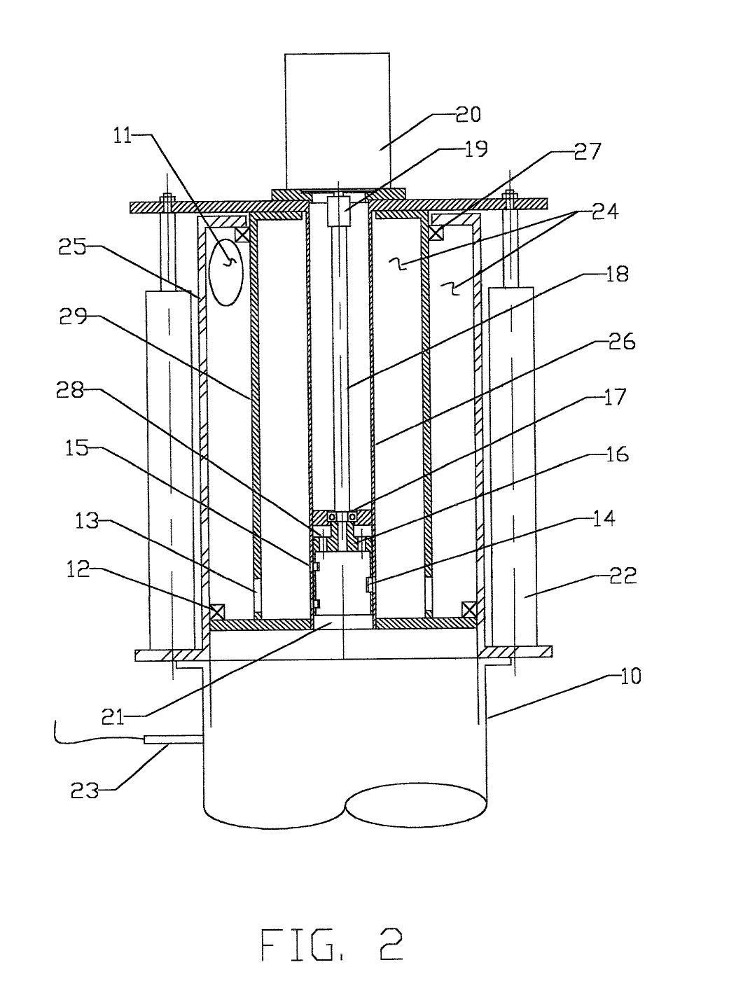

In a low frequency sound generator as depicted in FIG. 1 and 2, having a resonator tube 10 which is open on one end and closed on the other, with a pulser mechanism (FIG. 2) for introducing regulated puffs of compressed gas into the closed end of said resonator tube, compressed gas is fed into said pulser through a port 11 in the resonator tube extension 25 and subsequently through ports 13 in the extendable pulser case 29. The compressed gas resides in a reservoir 24 until it is passed through opening ports 14 in said pulser and passes into the closed end of the resonator tube 10 through opening 21.

The pulser can be of various configurations, with the one depicted being operated by an electric motor 20. Said motor is connected via coupling 19 to a ported, cylindrical rotor 16 through a shaft 18 which is held centered in a ported cylinder 26 by mechanical bearing means 17. The centering means also act as a pressure boundary between the inside of the resonator tube 10 and the motor 20. The rotor 16 has thru holes 28 in its bulkhead to prevent reversing thrust forces from being applied to the shaft 18 by the oscillating sound pressure in the resonator tube 10. The ported cylinder 26 is sealed to prevent leakage of the compressed gas from said reservoir 24 into said cylinder, except through the cylinder ports 15. As said motor 20 turns said rotor 16, the ports 14 in said rotor periodically line up with the ports 15 in the cylinder 26, allowing compressed gas in the reservoir 24 to move into the closed end of the resonator tube 10 through opening 21. Peak sound production is achieved by matching the frequency of the gas pulses to the fundamental frequency of the resonator tube, or one of its harmonics.

Matching one of these frequencies can be accomplished through various means. The system shown in FIG. 1 uses a pressure sensor 23 to measure the amplitude of the sound pressure in the closed end of the resonator tube. A controller is used to find the fundamental or harmonic frequency at which the sound generator is at peak resonance, thus comprising a feedback control scheme.

I claim:

1. In a sound generator, having a resonator tube with an open end and a closed end, with a pulsing mechanism on the closed end admitting puffs of compressed gas into the closed end of the resonator tube for purposes of producing sound waves out of the open end of the tube, said sound generator being capable of producing sound at frequencies determined by the length of the resonator tube, said frequencies being the fundamental tone where the wavelength is equal to four times the effective length of the resonator tube, and all harmonics, said pulsing mechanism residing inside the resonator tube or an extension of the resonator tube at the closed end, being movable along the axis of the resonator tube to change the effective length of the resonator tube thereby changing the sound frequencies at which resonance is produced, and providing the means of closure for the resonator tube through sealing means provided between the pulsing mechanism and the resonator tube to establish the closed end boundary of the resonator tube.

2. A sound generator according to claim 1 where adjusting means are provided for changing the location of the pulsing mechanism axially inside the resonator tube to change the effective length of the resonator tube and the corresponding resonant sound frequencies.

3. A sound generator according to claim 1 where the resonator tube or resonator tube extension acts as the compressed gas inlet for the pulsing mechanism, providing a stationary attachment point for the inlet compressed gas connection and a reservoir for containment of the compressed gas for admittance through the pulsing mechanism and into the resonator tube.

4. A sound generator according to claim 3 where a cylindrically shaped pulsing mechanism projects through a circular opening in the rear of the resonator tube, sealing means being provided between said pulsing mechanism and said resonator tube to prevent leakage of gas from the pulser to the surrounding atmosphere.

5. A sound generator according to claim 1 where inflatable seals provide sealing means that can have their active pressure changed during movement or stationary periods.

6. A sound generator according to claim 2 where threaded rods provide adjusting means for the effective length of the resonator tube that can be manually or automatically turned to change the axial position of the pulsing mechanism.

7. A sound generator according to claim 2 where hydraulically actuated cylinders provide adjusting means for the effective length of the resonator tube that can be adjusted manually or automatically.

8. A sound generator according to claim 1 where an electric motor driven rotor in a cylinder provides an opening and closing action for the pulsing mechanism, said motor being an ac motor driven by a variable frequency power supply turning said rotor that contains ports allowing compressed gas contained in a reservoir surrounding the cylinder to enter into the resonator tube through the cylinder in modulated puffs when said rotor ports align with ports in the cylinder.

9. A sound generator according to claim 8 where said motor speed is controlled by a digital automatic controller receiving sound pressure signals from the closed end of the resonator tube and adjusting the motor speed to attain resonance.

10. A sound generator according to claim 2 where the position of the pulsing mechanism is adjusted automatically by a digital controller to attain sound resonance in the resonator tube at the desired sound output frequency.

11. A method of generating a sound field inside of an enclosure for the purpose of agitating gas molecules to create useful turbulence where:
(a) one or more sound generators are installed around or within the enclosure for introducing sound into the enclosure;
(b) pressure transducers are installed in various locations throughout the enclosure to provide active indication of the sound pressure levels in those locations;
(c) a digital controller is used to control the sound generators to attain a resonating sound field within the enclosure.

12. The method of claim 11 where the frequency of the introduced sound is controlled to produce desired sound pressure levels at specific locations within the enclosure with the least amount of input energy by monitoring the sound pressure levels inside the enclosure at different sound input frequencies and utilizing frequencies where resonance is attained within the enclosure.

13. The method of claim 11 where the controller regulates the flow rate of compressed gas to the sound generator(s), thereby controlling the amount of sound energy introduced into the enclosure.

14. The method of claim 11 where multiple sound generators are simultaneously operated at the same frequency, and the phase relationship between the sound output from the generators is controlled to achieve favorable sound pressures in desired locations.

15. The method of claim 14 where the sound generators use servomotors to achieve matching output frequencies and control the phase relationship.
